(19) United States
(12) Patent Application Publication
(10) Pub. No.: US 2008/0023875 A1
(43) Pub. Date: Jan. 31, 2008

(54) Process for thermoforming a plastic film

(76) Inventors: Jean Claude Jammet, Neuhausen (CH); Oliver Muggil, Wetzikon (CH); Keizo Matsuo, Zurich (CH)

Correspondence Address: FISHER, CHRISTEN & SABOL, 1725 K STREET, N.W., SUITE 1108, WASHINGTON, DC, 20006, US

(21) Appl. No.: 11/819,629

(22) Filed: Jun. 28, 2007

(30) Foreign Application Priority Data
Jul. 6, 2006 (EP) 06405288.9

(51) Int. Cl. B29C 43/22; B28B 3/20; B29D 7/00

(52) U.S. Cl. 264/210.1; 264/165; 264/176.1

(57) ABSTRACT

A process, for manufacturing items out of a single or multi-layer plastic film having a thickness of at least 0.110 mm and featuring containers shape-formed out of the film plane by thermoforming, is such that a panel or strip-shaped flat material having a thickness of at least 0.4 mm is thinned before thermoforming by biaxial stretching in the longitudinal and transverse directions to the thickness of the plastic film. The biaxial stretching of the flat material leads to an improvement in the mechanical properties and barrier action against oxygen, water vapor and aromas.

The invention relates to a process for manufacturing items, made from a single or multi-layer plastic film having a thickness of at least 0.110 mm, featuring containers formed by thermoforming out of the film plane.

Thermoforming plastic films to form containers or cups out of the film plane is a method which is known for producing parts of packaging such as e.g. base parts of blister packs. The plastic film or films employed as starting material is/are normally manufactured in a continuous manner as flat material in the form of film strips, bands or panels, this in a known manner by means of extrusion or co-extrusion. In the production of flat material having a thickness of more than 400 μm the extruded plastic is cooled in strip form on a so called roll-stack unit. The material which is cut into individual leafs or panels is heated to the necessary temperature in a thermoforming machine, shape-formed in contact with a mould and then cooled.

The mechanical properties and the barrier action of the film strips is heavily dependent on the plastic material employed, on any additives that have been made, on the single or multi-layer structure and on the process conditions. In order for the material to be easily formed by thermoforming, the quality of the flat material used must be optimised. In particular the starting material for thermoforming should be as anisotropic as possible.

The conditions for thermoforming, such as temperature for example, depend in each case on the plastic used. For example, the thermoforming temperature for polypropylene (PP) is around 150° C. Proper filling of the mould by the plastic can be achieved e.g. by deep drawing using vacuum and/or by means of compressed air forming. A stamping tool may also be employed for shape-forming deep cups. The plastic material is stretched during the deformation process. The ratio of the final thickness after thermoforming to the initial thickness of the starting material generally lies between approx. 0.1 and 0.7.

The properties of the thermoformed final product are heavily dependent on the original properties of the flat material.

In order to improve their mechanical and barrier action properties, it is possible to biaxially stretch some plastics. Thus, it is possible to stretch polypropylene by a factor of eight in all axial directions. The biaxial stretching is carried out at a temperature close to the melting point of the semi-crystalline polymers. The elongation introduced by creating mechanical stress in the material improves the elastic modulus and reduces the permeability of gases, but on the other hand, leads to a pronounced drop in the elongation at fracture. Likewise, internal residual stresses are created in the film material. Because of the last mentioned negative effects, biaxially stretched flat materials have not been employed up to now for thermoforming containers

Known is the use of biaxial stretching for the production of plastic films of a thickness of 5 to about 100 μm. Such thin films with increased barrier properties and high elastic modulus are e.g. employed for the production of packaging material for packaging electronic components.

Basically, biaxial stretching can be achieved in two ways viz., in a two-step process involving sequential stretching in both axial directions longitudinal and transverse to the direction of the machines in question, or by simultaneous biaxial stretching in the longitudinal and transverse direction. Mono-axial stretching leads to a high degree of anisotropy and only slight improvement in the mechanical and barrier action properties, therefore this technology plays only an insignificant role.

Simultaneous biaxial stretching is obtained e.g. in films produced via blow-extrusion, however, the thickness of material that can be produced by this method is very limited and does not achieve the thickness necessary for thermoforming containers.

The process most widely used today for producing biaxially stretched films is extrusion or co-extrusion of a flat material which is subsequently biaxially stretched in two steps, normally first in the longitudinal direction then in the transverse direction.

Known from EP-B-1 274 576 is a thermo-formable, co-extruded and biaxially stretched multi-layer polyester film. The maximum thickness mentioned is 500 μm; the overall thickness of the polyester film given in the examples is, however, only 12 μm.

The object of the invention is to provide a process of the kind mentioned at the start, which enables thermoformed plastic films to be produced with a thickness of at least 0.110 mm and having containers such as e.g. base parts for blister packs made out of the film plane by thermoforming, the mechanical and barrier action properties of which are improved over those of state-of-the art thermo-formed films.

That objective is achieved by way of the invention in that a panel or strip-shaped flat material having the structure of the plastic film and a thickness of at least 0.4 mm before thermoforming, is thinned to the thickness of the plastic film by biaxial stretching in the longitudinal and transverse directions.

The improved mechanical and barrier action properties of the flat material also enable an improvement to be made in the corresponding properties in the final product. The principle properties which can be improved by biaxial stretching are:
barrier action against permeation of oxygen
barrier action against permeation of water vapour and gases such as aromatic substances
improvement in the elastic modulus
improvement in the transparency of the film

The flat material is preferably manufactured by way of extrusion or co-extrusion. The individual layers of a multi-layer structure may however be adhesively bonded to each other. Furthermore, the flat material may contain further layers such as e.g. a metallising layer, materials such as e.g. SiOₓ deposited in vacuum or lacquer.

Usefully, in biaxial stretching, the degree of stretching is the same in the longitudinal and transverse directions.

The biaxial stretching in the longitudinal and transverse directions is preferably performed simultaneously. This process enables biaxial stretching of films such as e.g. EVOH or PLA, which do not permit stretching a second time i.e. with the conventional two stage process biaxial stretching is not possible.

The ratio of stretching in the longitudinal and transverse directions is preferably 2:1 to 8:1, in particular 2:1 to 6:1. The biaxial stretching ratio must be optimised with respect to the subsequent thermoforming process in order that the mechanical and barrier action properties are achieved in the final product.

The minimum stretching ratio is given by the specification of the material employed, the barrier properties to be achieved and the mechanical properties desired in the final product, as well as the ability for the material or panel or strip-shaped flat materials to be stretched and to be processed to a strip or film with uniform thickness. The maximum biaxial stretching ratio is preferred as this enables the strip or film thickness, and thus the related problems with respect to flexibility, heating and cooling to be reduced. The minimum biaxial stretching ratio is achieved by employing optimum conditions such as temperature and rate during biaxial stretching. Also important is the adjustment of the raw materials with respect to molecular weight, composition and the rate and degree of crystallisation.

The plastic film is preferably a mono-film of polypropylene (PP) or a multi-layer film having at least one layer of polypropylene.

A particularly favoured plastic film is a multi-layer film made up of PP/bonding layer/EVOH or PP/bonding layer/EVOH/bonding layer/PP. The bonding layer is e.g. a maleic-acid-anhydride grafted polypropylene (MAH-PP). The layer of EVOH may also be replaced by polyamide, i.e. the plastic film is a multi-layer film comprising PP/bonding layer/polyamide (PA) or PP/bonding layer/PA/bonding layer/PP.

The monolayer or multi-layer structure may also contain a foamed polymer in order to reduce weight. Foamed polymer layers can be obtained during extrusion e.g. by employing foam inducing additives which cause gas to form, by subsequent thermal treatment or application of electromagnetic fields. A variety of plastics are suitable for foaming e.g. PS, PC PE and PP.

In order to improve the properties of the strip or film, the plastic may be laminated, before or after biaxial stretching, with other materials using various technologies e.g. by laminating with other monolayer or multi-layer films, by extrusion or co-extrusion coating or by coating with lacquers containing solvents or solvent-free lacquers.

The main field of application of the process according to the invention is seen to lie in the manufacture of items made from a flat material and having containers thermoformed out of the plane of the said flat material viz., as part of a form of packaging, in particular as base parts of blister packs for pharmaceutical and technical-medical products.

The invention is described in greater detail in the following with the aid of exemplified embodiments.

### EXAMPLES

The plastic material employed for the production of flat material is a homo-polypropylene of Basell: Moplen HP 522J, with a melt-flow rate of 3.0 g/10 min (230° C./2.16 kg) ISO 1133.

From the homopolypropylene, and using a cast-film machine, a flat material was produced with a thickness of 300 μm as a non-stretched reference material and in a thickness of 2.2 mm for the purpose of preparing stretched material.

The stretching of the flat material took place simultaneously in the longitudinal and transverse directions on a Bi-stretching unit on laboratory scale. Test material was produced with two different degrees of stretching:

Material A: stretch ratio in the longitudinal and transverse directions 4:1 (4×4) thickness 135 μm

Material B: stretch ratio in the longitudinal and transverse directions 6:1 (6×6) thickness 65 μm.

Subsequently, the films were processed on a pilot plant to produce blister base parts with 10 cylindrical cups 12 mm in diameter and 7 mm in depth, this for pharmaceutical applications. The thermoforming temperature was varied between 145 and 160° C. The time for shape-forming was between 1 and 3 sec. The negative pressure and positive pressure lay between 0 and 2 bar. The best thermoforming conditions lay at a temperature of 155° C., a vacuum time of 2.5 sec and a positive pressure time of 2 sec.

The elastic modulus and the elongation at fracture in the longitudinal direction (MD) and in the transverse direction (TD) were determined using a Zwick Z010 measuring instrument. The determination of the permeability of water vapour was carried out acc. to ASTM F 1249-90.

The results of testing are shown in tables 1 to 3.

TABLE 1

| | | | | Biaxial |
|---|---|---|---|---|
| | | Thickness | | stretching |
| No. | Material | (μm) | State | ratio |
| 1 | Homopolypropylene | 300 | cast film | 0 |
| 2 | Homopolypropylene | 300 | cast film | 0 |
| 3 | Homopolypropylene | 135 | biaxially stretched | 4 × 4 |
| 4 | Homopolypropylene | 135 | biaxial stretched | 4 × 4 |
| 5 | Homopolypropylene | 65 | biaxial stretched | 6 × 6 |
| 6 | Homopolypropylene | 65 | biaxial stretched | 6 × 6 |
| 11 | PVC | 250 | cast film | 0 |

TABLE 2

| | | | | E-Modulus | Elongation at | Elongation at |
|---|---|---|---|---|---|---|
| | | E-Modulus | E-Modulus | (MD) | fracture | fracture |
| | Thickness | (MD) | (TD) | increase | (MD) | (TD) |
| No. | [μm] | [N/mm²] | [N/mm²] | [%] | [%] | [%] |
| 1 | 140 | 493 | 503 | | 970 | 873 |
| 2 | 182 | 519 | 519 | | 790 | 880 |
| 3 | 120 | 2350 | 2570 | 352 | 155 | 174 |
| 4 | | | | | | |
| 5 | 65 | 2720 | 2770 | 423 | 112 | 105 |
| 6 | | | | | | |
| 11 | | 3000 | 3000 | | | |

TABLE 3

| | | | | Variation in | |
|---|---|---|---|---|---|
| | | | | thickness after | |
| | | Permeability | | thermoforming | |
| | Thick- | of water | Permeability of | Base | Base |
| | ness | vapour | water vapour (*) | edge | middle |
| No. | [μm] | [g/m² · d · b] | [g/m² · d · b] | [%] | [%] |
| 1 | 140 | 1.83 | 1.02 | | |
| 2 | 182 | 1.56 | 1.14 | 12 | 22 |
| 3 | 142 | 1 | 0.57 | | |
| 4 | 133 | 1.06 | 0.56 | 26 | 33 |
| 5 | 68 | 2.21 | 0.60 | | |
| 6 | 68 | 2.16 | 0.59 | 20 | 30 |
| 11 | | | | 20 | 34 |

(*) with reference to a thickness of 250 μm

The results show that polypropylene can be simultaneously biaxially stretched with a low stretch ratio, whereby the elastic modulus and the barrier action against water vapour are greatly increased. The variation in thickness at the thermoformed cup is better in the biaxially stretched material than in the non-stretched reference material and is comparable to PVC or PVDC material.

1. A process for manufacturing items out of a single or multi-layer plastic film having a thickness of at least 0.110 mm, with containers formed out of the film plane by thermoforming, thinning a flat material in panel or strip-shape form having a thickness of at least 0.4 mm and with the structure corresponding to that of the plastic film before thermoforming by biaxial stretching in the longitudinal and transverse directions to the thickness of the plastic film.

2. The process according to claim 1, wherein the flat material is manufactured by extrusion or co-extrusion.

3. The process according to claim 2, wherein the stretch ratio is the same in the longitudinal and transverse directions.

4. The process according to claim 3, wherein the stretching is performed simultaneously in the longitudinal and transverse directions.

5. The process according to claim 4, wherein the stretch ratio in the longitudinal and transverse directions is 2:1 to 8:1.

6. The process according to claim 5, wherein the plastic film is a monofilm of polypropylene (PP) or a multi-layer film having at least one layer of polypropylene.

7. The process according to claim 7 wherein the plastic film is a multi-layer film made up of PP/bonding layer/EVOH or PP/bonding layer/EVOH/bonding layer/PP.

8. The process according to claim 5, wherein the plastic film is a multi-layer film made up of PP/bonding layer/polyamide (PA) or PP/bonding layer/PA/bonding layer/PP.

9. The process according to claim 5, wherein the plastic film is a monofilm or multi-layer film having at least one foamed layer.

10. A process of utilizing the items manufactured using the process according to claim 1, as part of a form of packaging.

11. The process according to claim 4, wherein the stretch ratio is the same in the longitudinal and transverse directions.

12. The process according to claim 5, wherein the plastic film is a monofilm or multi-layer film having a 3 layer structure made up of PP/foamed PP/PP or PE/foamed PE/PE.

13. The process according to claim 1, wherein the stretch ratio is the same in the longitudinal and transverse directions.

14. The process according to claim 1, wherein the stretching is performed simultaneously in the longitudinal and transverse directions.

15. The process according to claim 1, wherein the stretch ratio in the longitudinal and transverse directions is 2:1 to 8:1.

16. The process according to claim 1, wherein the plastic film is a monofilm of polypropylene (PP) or a multi-layer film having at least one layer of polypropylene.

17. The process according to claim 1, wherein the plastic film is a multi-layer film made up of PP/bonding layer/EVOH or PP/bonding layer/EVOH/bonding layer/PP.

18. The process according to claim 1, wherein the plastic film is a multi-layer film made up of PP/bonding layer/polyamide (PA) or PP/bonding layer/PA/bonding layer/PP.

19. The process according to claim 1, wherein the plastic film is a monofilm or multi-layer film having at least one foamed layer.

20. The process according to claim 1, wherein the stretch ratio in the longitudinal and transverse directions is 2:1 to 6:1.

21. The process according to claim 1, wherein that the plastic film is a monofilm or multi-layer film having a 3 layer structure made up of PP/foamed PP/PP or PE/foamed PE/PE.

22. A process for manufacturing items out of a single or multi-layer plastic film having a thickness of at least 0.110 mm, with containers formed out of the film plane by thermoforming, thinning a flat material in panel or strip-shape form having a thickness of at least 0.4 mm and with the structure corresponding to that of the plastic film, before thermoforming, by biaxial stretching in the longitudinal and transverse directions to the thickness of the plastic film, and thermoforming the plastic film into the items.
